(19) United States
(12) Patent Application Publication
(10) Pub. No.: US 2005/0225509 A1
(43) Pub. Date: Oct. 13, 2005

(54) Plasma display panel and driving method thereof

(76) Inventors: Hak-Ki Choi, Suwon-si (KR); Su-Jin Park, Suwon-si (KR)

Correspondence Address: CHRISTIE, PARKER & HALE, LLP, PO BOX 7068, PASADENA, CA, 91109-7068, US

(21) Appl. No.: 11/104,239

(22) Filed: Apr. 11, 2005

(30) Foreign Application Priority Data
Apr. 12, 2004 (KR) 10-2004-0024872

(51) Int. Cl. G09G 3/28

(52) U.S. Cl. 345/60

(57) ABSTRACT

A driving method of a plasma display panel. First and second electrodes are formed in parallel. Third electrodes respectively cross the first and second electrodes. Discharge cells are formed by adjacent first and second electrodes, and third electrodes. A main reset pulse has a waveform falling after rising to a second voltage from a first voltage. A sub reset pulse has a waveform falling from a third voltage to a fourth voltage. The main reset pulse and the sub reset pulse selectively are applied to a plurality of subfields. A misfiring erase pulse is applied after the main reset pulse is applied during a reset period of a subfield to which the main reset pulse is initially applied.

### CROSS REFERENCE TO RELATED APPLICATION

This application claims priority to and the benefit of Korean Patent Application No. 10-2004-0024872 filed on Apr. 12, 2004, the entire content of which is incorporated herein by reference.

### BACKGROUND OF THE INVENTION

1. Field of the Invention

The present invention relates to a plasma display panel (PDP) and a driving method thereof.

2. Description of the Related Art

A plasma display panel (PDP) is a flat panel display that uses plasma generated by gas discharge to display characters or images, and includes, according to its size, more than several scores to millions of pixels arranged in a matrix pattern. Referring to FIG. 1 and FIG. 2, a structural overview of the PDP will be described.

FIG. 1 is a schematic perspective view partially illustrating a PDP. FIG. 2 shows a configuration of a general PDP. The PDP includes glass substrates 1, 6 facing each other with a predetermined gap therebetween. Pairs of a scan electrode 4 and a sustain electrode 5 are formed in parallel on the glass substrate 1, and the scan electrodes 4 and the sustain electrodes 5 are covered with a dielectric layer 2 and a protection film 3. A plurality of address electrodes 8 is formed on a glass substrate 6, and the address electrodes 8 are covered with an insulator layer 7. Barrier ribs 9 are formed on the insulator layer 7 between the address electrodes 8, and phosphors 10 are formed on the surface of the insulator layer 7 and between the barrier ribs 9. The glass substrates 1, 6 are provided facing each other with discharge spaces 11 between the glass substrates 1, 6 so that the scan electrodes 4 and the sustain electrodes 5 can respectively cross the address electrodes 8. The discharge space 11, between an address electrode 8 and a crossing portion formed by a pair of a scan electrode 4 and a sustain electrode 5, forms a discharge cell 12.

Further, as shown in FIG. 2, the PDP includes a plasma panel 100, a controller 200, an address electrode driver 300, a scan electrode (hereinafter, referred to as a “Y electrode”) driver 400, and a sustain electrode (hereinafter, referred to as a “X electrode”) driver 500.

The plasma panel 100 includes a plurality of address electrodes A1 to Am arranged in the column direction, and a plurality of X electrodes X1 to Xn arranged in the row direction. In general, the X electrodes are formed in correspondence to the X electrodes with one terminal thereof commonly coupled to one terminal of each X electrode. Herein, a discharge cell is defined by a pair of X and Y electrodes and an address electrode crossing the pair of the X and Y electrodes. The controller 200 externally receives an image signal, and outputs an address electrode driving signal, an X electrode driving signal, and a Y electrode driving signal. In addition, the controller 200 time-divides one frame into a plurality of subfields, and each subfield is divided into a reset period, an addressing period, and a sustain period.

The address electrode driver 300 receives the address electrode driving signal from the controller 200, and applies display data signals to respective address electrodes A1 to Am for selecting desired discharge cells. The X electrode driver 500 receives the X electrode driving signal from the controller 200, and applies a driving voltage to the respective address electrodes A1 to Am. The Y electrode driver 400 receives the Y electrode driving signal from the controller 200, and applies a driving voltage to the respective Y electrodes Y1 to Yn.

In general, a signal frame of the PDP is divided into a plurality of subfields, and combinations of the mulitple subfields represent gray scales. Each of the subfields include a reset period, an address period, and a sustain period. In the reset period, wall charges formed by a pervious sustain-discharge are erased, and each cell is reset to stably perform the next addressing. In the addressing period, cells are selectively turned on and turned off and the wall charges are accumulated on the turned-on cells (i.e., addressed cell). In the sustain period, a sustain-charge is performed so as to display an image to the addressed cells.

Referring to FIG. 3, a driving method of a conventional PDP will be described using a conventional waveform. As shown therein, the reset period is divided into an erasing period, a ramp rising period, and a ramp falling period.

In the erasing period, an erasing ramp waveform gradually rising from 0V to a voltage Vₑ is applied to the sustain electrode X. Then, the wall charges formed in the sustain electrode X and the scan electrode Y are gradually erased.

In the ramp rising period, the address electrode A and the sustain electrode X are maintained at 0V, and a ramp waveform gradually rising from a voltage Vₛ to a voltage Vₛₑₜ is applied to the scan electrode Y. A first weak reset discharge occurs from the scan electrode Y to the address electrode A and the sustain electrode X in the discharge cells while the ramp waveform is rising. Negative wall charges are accumulated on the scan electrode Y and positive wall charges are concurrently accumulated on the address electrode A and the sustain electrode X.

In the ramp falling period, the ramp waveform gradually falling from a voltage Vₛ to 0V is applied to the scan electrode Y while the sustain electrode X is maintained at the voltage Vₑ. A second weak reset discharge occurs to the discharge cells and thus the negative wall charges in the scan electrode Y and the positive wall charges in the sustain electrode X are reduced.

Thus, when the reset period is normally operated, the wall charges in the scan electrode Y and the sustain electrode X are erased, but a discharge may unstably occur in the following situations: (a) that the discharge occurs due to self-erasing while the voltage Vₑₛₜ of the scan electrode Y falls when a strong discharge has been occurred during the ramp rising period, (b) that the strong discharge occurs during the ramp rising period and the ramp falling period, and (c) that the strong discharge occurs during the ramp falling period. In the case of (a), a reset process is performed due to the self-erasing.

However, in the cases of (b) and (c), the positive wall charges are accumulated on the scan electrode Y and the negative wall charges are accumulated on the sustain electrode X due to the strong discharge during the ramp falling period. A sustain discharge may occur during the sustain period without an occurrence of an address discharge in the address period when a wall voltage V_{wxy1} formed by the wall charges on the scan electrode Y and the sustain electrode X satisfies the Equation 1.
V_{wxy1}+Vₛ>V_{f} [Equation 1]
wherein the voltage V_{wxy1} represents the wall charge formed between the scan electrode Y and the sustain electrode X due to the strong discharge during the ramp falling period; the voltage Vₛ represents a voltage difference generated between the scan electrode Y and the sustain electrode X due to a first sustain pulse applied during the sustain period; and the voltage V_{f} represents a discharge firing voltage between the scan electrode Y and the sustain electrode X.

With the foregoing conventional driving method, the sustain discharges may occur to un-selected discharge cells due to the strong discharge in the ramp falling period of the reset period.

### SUMMARY OF THE INVENTION

In accordance with the present invention a driving method of a PDP is provided to prevent misfiring formed by a strong discharge in a reset period, and yields a timing margin of a logic input signal by selectively applying a misfiring erase pulse waveform per subfield.

The present invention discloses a driving method of a PDP having a plurality of first electrodes and second electrodes formed in parallel; a plurality of third electrodes respectively crossing the first and second electrodes; a discharge cell formed by the adjacent first and second electrodes, and third electrodes; and a main reset pulse having a waveform rising to a second voltage from a first voltage and then falling, and a sub reset pulse having a waveform falling from a third voltage to a fourth voltage, the main reset pulse and the sub reset pulse being selectively applied to a plurality of subfields. A misfiring erase pulse is applied after the main reset pulse is applied during a reset period of a subfield to which the main reset pulse is initially applied.

The misfiring erase pulse performs discharging and erasing under a predetermined condition, such as when charges are formed excessively during the reset period, the excessive charges being erased by the misfiring erase pulse.

The misfiring erase pulse is applied after a main reset pulse is applied during a reset period of a subfield applied with the main reset pulse, the subfield coming after a subfield applied with a sub reset pulse.

In the case that the subfields to which the sub reset pulse is applied are consecutive, the misfiring erase pulse is applied to a subfield to which the main reset pulse is initially applied.

The present invention also discloses a PDP having a plurality of first and second electrodes formed in parallel; a plurality of third electrodes crossing the first and second electrodes. A driving circuit supplies a driving signal to a discharge cell formed by the adjacent first and second electrodes, and third electrodes, and selectively applies a main reset pulse having a waveform rising to a second voltage from a first voltage and then falling, and a sub reset pulse having a waveform falling from a third voltage to a fourth voltage during a reset period throughout subfields.

The driving circuit applies a misfiring erase pulse after applying the main reset pulse during a reset period of a subfield to which the main reset pulse is initially applied.

### BRIEF DESCRIPTION OF THE DRAWINGS

FIG. 1 is a schematic perspective view partially illustrating a PDP.

FIG. 2 shows a configuration of a general PDP.

FIG. 3 is a driving waveform of a conventional PDP.

FIG. 4 is a driving waveform of a PDP according to a first embodiment of the present invention.

FIGS. 5A, 5B, 5C and 5D are distribution diagrams of wall charges resulting from the driving waveforms of FIG. 4.

FIGS. 6A, 6B and 6C are distribution diagrams of the wall charges in FIG. 4 under an occurrence of an unstable reset operation.

FIG. 7 is an exemplary modification case of the driving waveform in FIG. 4.

FIG. 8 is a driving waveform of the PDP according to a second embodiment of the present invention.

FIG. 9 is a driving waveform of the PDP according to third to fifth embodiments of the present invention.

FIG. 10 shows a driving waveform of the PDP according to a fourth embodiment of the present invention.

FIG. 11 shows a driving waveform of the PDP according to the fifth embodiment of the present invention.

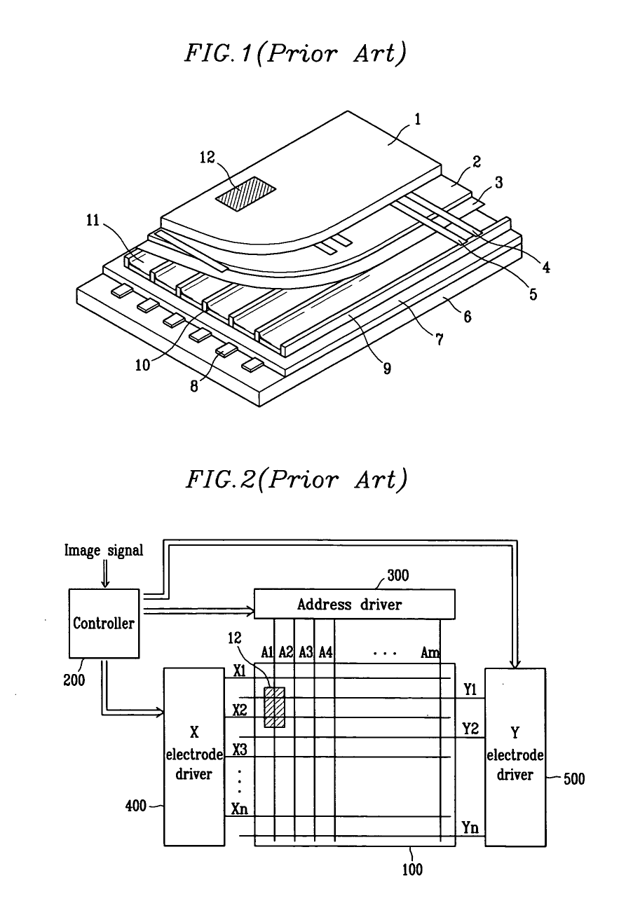

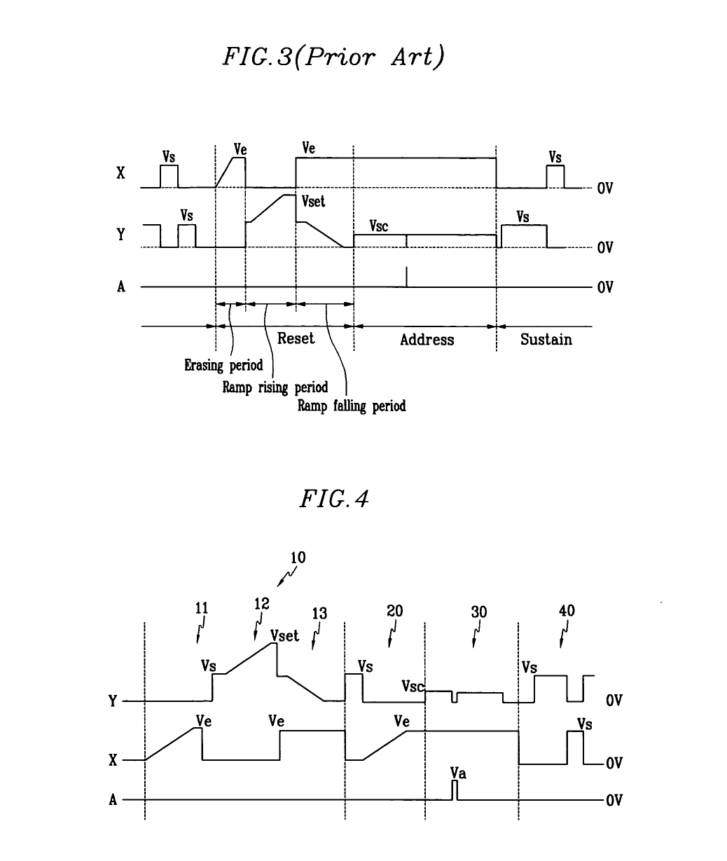

### DETAILED DESCRIPTION

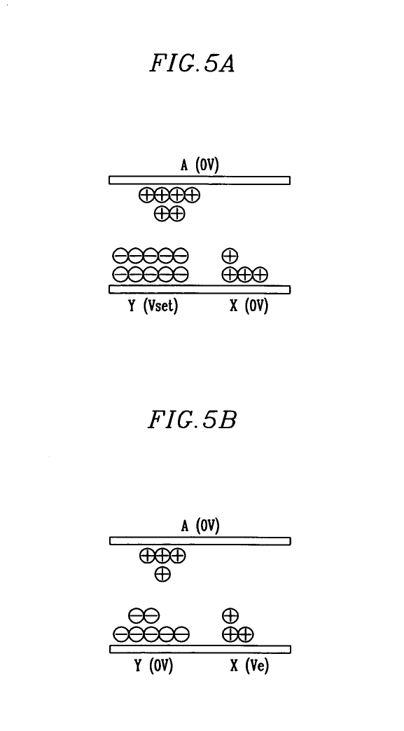

Referring now to FIG. 4, the driving waveform according to the first embodiment of the present invention includes a reset period 10, a misfiring erase period 20, an address period 30, and a sustain period 40. The reset period 10 is divided into an erasing period 11, a ramp rising period 12, and a ramp falling period 13.

In the erasing period 11, the charges formed due to a sustain discharge during the sustain period 40 of a previous subfield are erased. In the ramp rising period 12, the wall charges are formed at the scan electrode Y, the sustain electrode X, and the address electrode A. During the ramp falling period 13, the wall charges formed during the ramp rising period are partially erased for the address discharge.

In the misfiring erasing period 20, the wall charges formed between the scan electrode Y and the sustain electrode X due to an unstable strong discharge during the ramp falling period 13 are erased.

In the address period 30, a discharge cell which will trigger an occurrence of the sustain discharging is selected among a plurality of discharge cells. During the sustain period 40, a sustain pulse is alternately applied to the scan electrode Y and the sustain electrode X to thus sustain-discharge the discharge cells which have been selected in the address period 30.

Further, the PDP includes a scan/sustain driving circuit for applying a driving voltage to the scan electrode Y and the sustain electrode X, and an address driving circuit for applying the driving voltage to the address electrode A in the respective periods 10, 20, 30, 40.

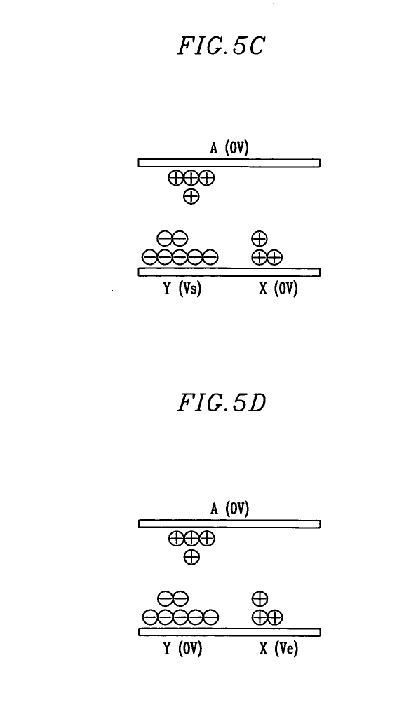

Normal reset pursuant to the driving waveform according to the first embodiment of the present invention will now be described in more detail with reference to FIGS. 5A to 5D.

In the sustain period 40 of the previous subfield, negative wall charges are accumulated on the scan electrode Y and positive wall charges are concurrently accumulated on the sustain electrode X by the sustain discharge between the scan electrode Y and the sustain electrode X. In the erasing period 11, the voltage of the scan electrode Y is set as a reference voltage, and a ramp waveform gradually rising from the reference voltage to the voltage Vₑ is applied to the sustain electrode X. According to the first embodiment of the present invention, the reference voltage is established to be 0V. Then, the wall charges formed the sustain electrode X and the scan electrode Y are gradually erased.

In the ramp rising period 12, the voltage of the sustain electrode X is set as the reference voltage, and the ramp waveform gradually rising from the voltage Vₛ to the voltage Vₛₑₜ is applied to the scan electrode Y. The voltage Vₛ is lower than the discharge firing voltage V_{f} between the scan electrode Y and the sustain electrode X, and the voltage Vₛₑₜ is higher than the discharge firing voltage V_{f}. Then, weak reset discharges respectively occur at the address electrode A and the sustain electrode X from the scan electrode Y while the ramp waveform is rising. The negative wall charges are accumulated on the scan electrode Y and the positive wall charges are concurrently accumulated on the address electrode A and the sustain electrode X, as shown in FIG. 5A.

In the ramp falling period 13, the sustain electrode X is maintained at the voltage Vₑ, and the ramp waveform gradually falling from the voltage Vₑ to the reference voltage is applied to the scan electrode Y. The weak reset discharges occur at the discharge cells while the ramp waveform is falling. The negative wall charges in the scan electrode Y and the positive wall charges in the sustain electrode X are reduced as shown in FIG. 5B. Further, the positive wall charges on the address electrode A are adjusted to be appropriate for the addressing operation.

During the misfiring erase period 20, the sustain electrode X is maintained at the reference voltage, and a square-shaped pulse having the voltage Vₛ is applied to the scan electrode Y. In the case that the charges are normally erased in the ramp falling period 13, the wall charges formed between the scan electrode Y and the sustain electrode X become a negative voltage −V_{wxy2} when the scan electrode Y is set to be the reference voltage. Then, the voltage between the scan electrode Y and the sustain electrode X becomes Vₛ-V_{wxy2} which is not higher than the discharge firing voltage V_{f}, and thus no discharge occurs. Therefore, distribution of the wall charges in the discharge cells shown in FIG. 5C is maintained to be the same as that shown in FIG. 5B.

In the misfiring erase period 20, the scan electrode Y is maintained at the reference voltage, and an erasing ramp waveform gradually rising to the voltage Vₑ from the reference voltage is applied to the sustain electrode X. The distribution of the charges at the scan electrode Y and the sustain electrode X is maintained to be the same as that in the previous period, and thus no discharge occurs as a result of the erasing ramp waveform. Therefore, the wall charges shown in FIG. 5D are maintained in a like manner of those shown in FIG. 5B.

In the address period 30, the scan pulse is sequentially applied to the scan electrode Y to select the discharge cell, and the address pulse is applied to a desired address electrode A selected among the address electrodes A which cross the scan electrode Y to which the scan pulse is applied. Then, the discharge occurs between the scan electrode Y and the address electrode A by a potential difference formed between the scan pulse and the address pulse. Further, the discharge between the scan electrode Y and the sustain electrode X occurs when the discharge between the scan electrode Y and the address electrode A starts, thereby forming the wall charges to the scan electrode Y and the sustain electrode X.

In the sustain period 40, the sustain pulse is alternately applied to the scan electrode Y and the sustain electrode X. The sustain pulse allows the voltage difference between the scan electrode Y and the sustain electrode X alternately to be Vₛ and 0V. The voltage Vₛ is lower than the discharge firing voltage between the scan electrode Y and the sustain electrode X. In the address period 30, when a wall voltage V₃ is formed between the scan electrode Y and the sustain electrode X due to the address discharge, a discharge occurs on the scan electrode Y and the sustain electrode X due to the wall voltage V_{wxy3} and the voltage Vₛ.

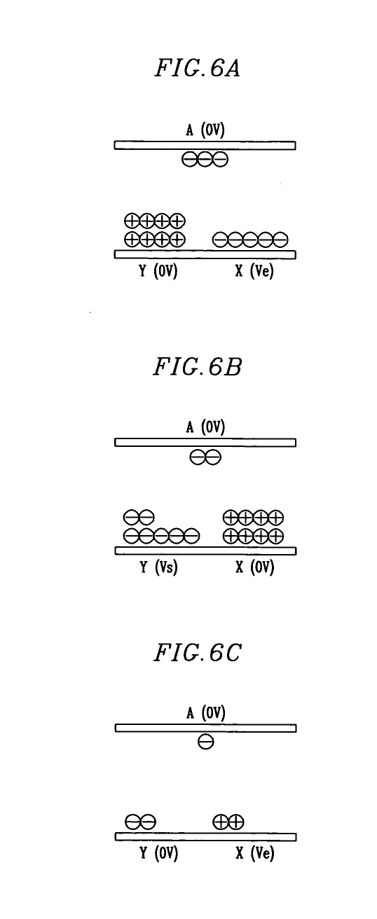

An occurrence of a strong discharge in the ramp falling period 13 of the driving waveform according to the first embodiment of the present invention will be described in detail with reference to FIGS. 6A, 6B and 6C.

The unstable reset operation results in an occurrence of the strong discharge during the ramp falling period 13, and sequentially the positive wall charges are accumulated on the scan electrode Y and the negative wall charges are concurrently accumulated on the sustain electrode X, as shown in FIG. 6A. Herein, the wall voltage V_{wxy1} formed by the wall charges provided on the scan electrode Y and the sustain electrode X satisfies the previous Equation 1.

When the voltage Vₛ is applied to the scan electrode Y and the reference voltage is applied to the sustain electrode X in the misfiring erase period 20, the wall voltage V_{wxy1} between the scan electrode Y and the sustain electrode X and the voltage Vₛ make the voltage (V_{wxy1}+Vₛ) between the scan electrode Y and the sustain electrode X exceed the discharge firing voltage V_{f}. A discharge is accordingly occurs between the scan electrode Y and the sustain electrode X, and a large amount of the negative wall charges and the positive wall charges are respectively accumulated on the scan electrode Y and the sustain electrode X, as shown in FIG. 6B.

An erasing ramp waveform gradually rising from the reference voltage to the voltage Vₑ is applied to the sustain electrode X in the latter part of the misfiring erase period 20 to thus cause an erase operation. The wall charges formed to the scan electrode Y and the sustain electrode X are erased by the erase ramp waveform shown in FIG. 6C, and thus the wall voltage between the scan electrode Y and the sustain electrode X is reduced. Accordingly, the sum of the wall voltage between the scan electrode Y and the sustain electrode X and the voltage Vₛ applied during the sustain period 30 becomes lower than the discharge firing voltage V_{f}. Therefore, no discharge occurs in the sustain period 40 without the occurrence of the address discharge during the address period 30.

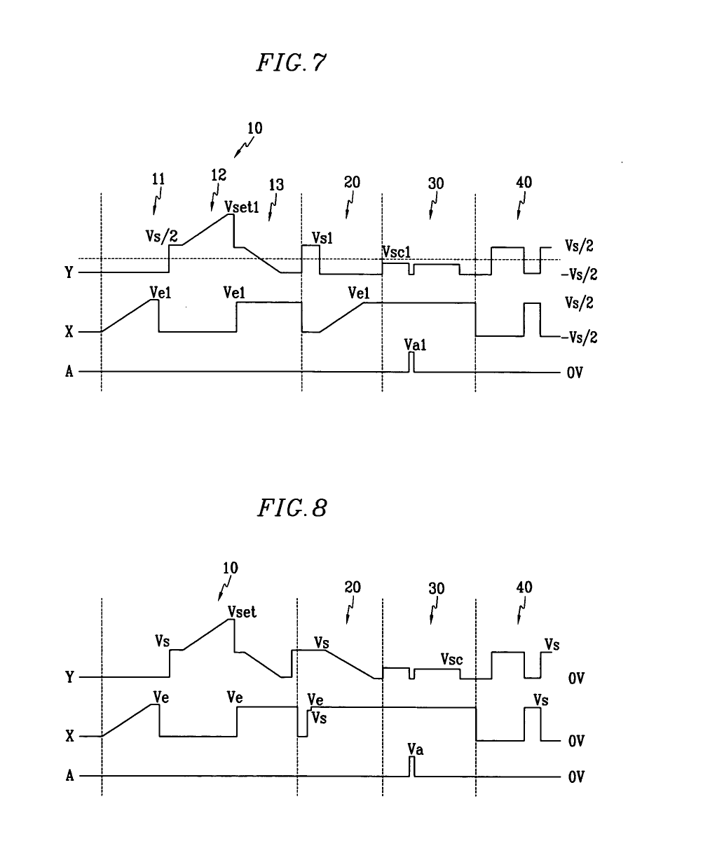

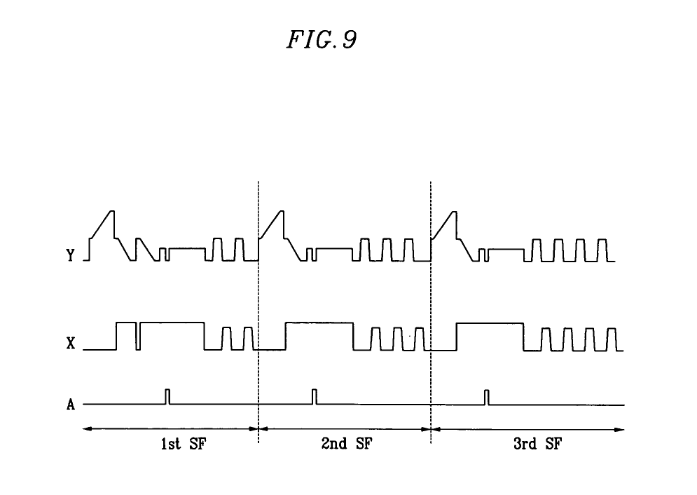

According to the first embodiment of the present invention, the voltage Vₛ is applied to the scan electrode Y and the voltage Vₑ is applied to the sustain electrode X during the misfiring erase period 20 to simplify the driving circuit. However, a different voltage may be applied to the scan electrode Y and the sustain electrode X as long as the different voltage satisfies a discharging condition during the misfiring erase period 20. The reference voltage according to the first embodiment of the present invention is set to 0V, but it may further be set to −Vₛ/2. As shown in FIG. 7, the driving voltages applied to the scan electrode Y and the sustain electrode X in the respective periods (the reset period 10, the misfiring erase period 20, the address period 30, and the sustain period 40) are reduced by Vₛ/2, altogether. Thus, a voltage level applied to the driving circuit is reduced, and accordingly, elements requiring low withstanding voltages may be applied thereto. Further, the voltages applied to the respective periods (the reset period 10, the misfiring erase period 20, the address period 30, and the sustain period 40) may be varied according to other embodiments of the present invention.

In addition, according to the first embodiment of the present invention, the erase ramp waveform is applied to the sustain electrode X in the erase period 11, but the erase ramp waveform may be applied to the scan electrode Y.

Further, the ramp raising voltage and the ramp falling voltage are applied to the scan electrode Y as a reset voltage according to the first embodiment of the present invention. However, different reset voltages may also be applied unless distribution diagrams of the wall charges resulting from a normal reset operation and an abnormal reset operation are not the same as shown in FIG. 5B and FIG. 6A, respectively.

The foregoing modifications may be applied to other embodiments which will be described hereinafter.

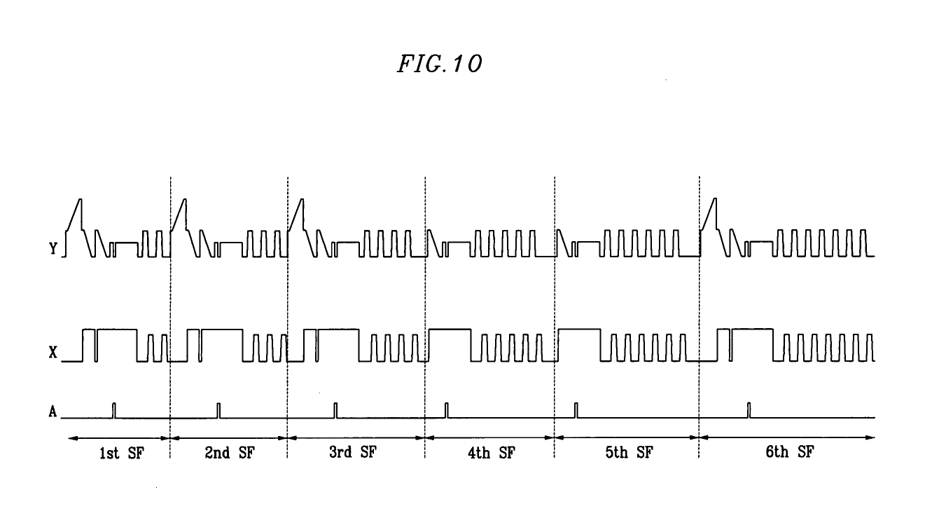

According to the first embodiment of the present invention, the discharge voltage and the erase ramp waveform are used in the misfiring erase period 20, but different waveforms may also be applied thereto. Hereinafter, a second embodiment using a different waveform in the misfiring erase period 20 will be described with reference to FIG. 8.

FIG. 8 is a PDP driving waveform according to the second embodiment of the present invention. As shown therein, a square pulse is applied to the sustain electrode X and a ramp waveform is applied to the scan electrode Y in the misfiring erase period 20, according to the second embodiment, differing from the first embodiment. In more detail, the scan electrode Y is maintained at the voltage Vₛ, and the square pulse having the reference voltage is applied to the sustain electrode X in an early stage of the misfiring erase period 20. Then, the voltage difference between the scan electrode Y and the sustain electrode X is maintained at the voltage Vₛ as described in the first embodiment of the present invention, and thus a discharge occurs between the scan electrode Y and the sustain electrode X when the strong discharge occurs during the ramp falling period 13. In the latter part of the misfiring erase period 20, a ramp waveform falling to the reference voltage from the voltage Vs is applied to the scan electrode Y while the sustain electrode X is maintained at the voltage Vₑ. Charges formed by the discharge between scan electrode Y and the sustain electrode X in the early stage of the misfiring erase period 20 may be erased by the ramp waveform. A round waveform may be replaced with the ramp waveform.

However, the misfiring erase pulse waveforms according to the first and second embodiments of the present invention may be applied to a selective ramp reset method employed to achieve a high contrast ratio of the PDP. In other words, the misfiring erase pulse waveform may be selectively applied to a selective ramp reset operation.

According to the selective ramp reset method, a sub reset pulse is partially applied to the subfields instead of applying a rising ramp reset pulse (hereinafter, referred to as a main reset) thereto.

Third to fifth embodiments are related to an example of applying the misfiring erase pulse waveform to the selective ramp reset according to the embodiments of the present invention.

FIG. 9 shows a driving waveform of a PDP according to the third embodiment of the present invention, illustrating the misfiring erase pulse waveform according to the second embodiment. Other waveforms including a round waveform may be replaced therewith.

In a driving method according to the third embodiment of the present invention, a misfiring erase function waveform (hereinafter, referred to as a MEF waveform) is applied to a first subfield (SF) and is erased in the second and third subfields.

When the rising ramp pulse is output from each subfield, the MEF waveform is applied to an initial subfield to prevent discharge misfiring since the whole sides of a panel are reset with plenty of wall charges thereby to maintain uniformity thereof.

In the case of the third embodiment of the present invention, the MEF waveforms are applied to the minimum thereby yielding a timing margin in the generation of driving signals and reducing stress on a switch for outputting the MEF waveform to less than half.

FIG. 10 shows a driving waveform of the PDP according to a fourth embodiment of the present invention. The driving waveform shown therein is the same as the MEF waveform according to the third embodiment of the present invention as shown in FIG. 9, and the waveform in the first embodiment or other waveforms including a round waveform may also be applied thereto. It may also by applied to the fifth embodiment described below, as well.

As shown in FIG. 10, when the selective ramp reset waveform is applied, first, second, third, and sixth subfields perform a main reset operation whereas fourth and fifth subfields perform a sub reset operation. Herein, charges of the subfields performing the main reset operation are more evenly distributed than those of the subfields performing the sub reset operation. Therefore, the misfiring does not occur in the second and third subfields although no MEF waveform is applied thereto.

The number of subfields according to the exemplary embodiments of the present invention is set to be six, but is not limited thereto the total number of subfields may be modified and positions of the main reset and the sub reset will be modified accordingly. This modification may be applied to a fifth embodiment of present invention.

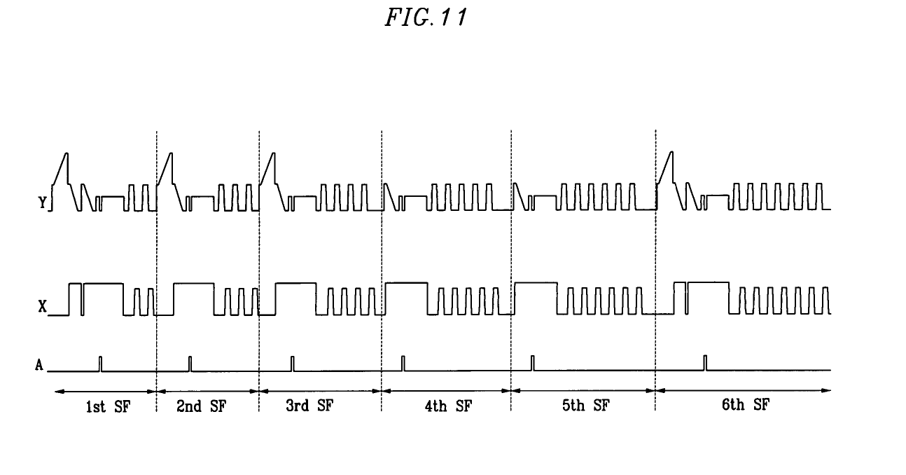

FIG. 11 shows a driving waveform of the PDP according to the fifth embodiment of the present invention. No MEF waveform is applied to the second and third subfields performing the main reset operation, but is applied to the sixth subfield. Herein, the fourth and fifth subfields perform the sub reset operation. Since the charges of the panel in the subfields performing the sub reset operation (e.g., the fourth and fifth subfields) become unevenly distributed, the MEF waveform is applied to the consecutive main subfield performing the main reset operation. However, the amount of the MEF waveform applied thereto is somewhat less than that of the fourth embodiment of the present invention, thereby yielding a timing margin for logic input signals.

With reference to the above-described embodiments, charges abnormally formed by a strong discharge formed to the scan electrode and the sustain electrode in a reset period due to an unstable reset operation can be erased. Accordingly, an occurrence of sustain discharging in unselected cells can be prevented.

In particular, a misfiring erase pulse can be selectively applied to yield a timing margin for logic input signals in the case of selective reset driving. In other words, the timing margin of the logic input signal is yielded by a degree in which the MEF waveform is applied to the minimum. Consequently, the sustain discharging is additionally applied thereto, thereby increasing peak brightness of the PDP.

In addition, stress on the switch for outputting the MEF waveform can be consequently reduced by reducing the number of times that MEF waveform is output.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A driving method of a plasma display panel having a plurality of first electrodes and second electrodes, a plurality of third electrodes respectively crossing the first and second electrodes, a discharge cell formed by the adjacent first and second electrodes, and third electrodes, and a main reset pulse having a waveform rising to a second voltage from a first voltage and then failing, and a sub reset pulse having a waveform falling from a third voltage to a fourth voltage, the main reset pulse and the sub reset pulse being selectively applied to a plurality of subfields; the driving method comprising:
applying a misfiring erase pulse after the main reset pulse is applied during a reset period of a subfield to which the main reset pulse is initially applied.

2. The driving method according to claim 1, wherein the misfiring erase pulse performs discharging and erasing under a predetermined condition.

3. The driving method according to claim 2, wherein the predetermined condition includes having charges formed excessively during the reset period, and wherein the charges formed excessively are discharged and erased by the misfiring erase pulse.

4. The driving method according to claim 1, wherein the misfiring erase pulse is applied after a main reset pulse is applied during a reset period of a subfield applied with the main reset pulse, the subfield coming after a subfield applied with a sub reset pulse.

5. The driving method according to claim 1, wherein, in the case that subfields to which the main reset pulse is applied are consecutive, the misfiring erase pulse is applied to a subfield to which the main reset pulse is initially applied.

6. The driving method according to claim 4, wherein in the case that subfields to which the main reset pulse is applied are consecutive, the misfiring erase pulse is applied to a subfield to which the main reset pulse is initially applied.

7. A plasma display panel comprising:
a plurality of first and second electrodes formed in parallel;
a plurality of third electrodes crossing the first and second electrodes; and
a driving circuit supplying a driving signal to a discharge cell formed by the adjacent first, second, and third electrodes, and selectively applying a main reset pulse having a waveform rising to a second voltage from a first voltage and then falling and a sub reset pulse having a waveform falling from a third voltage to a fourth voltage during a reset period throughout subfields,
wherein the driving circuit applies a misfiring erase pulse after applying the main reset pulse during a reset period of a subfield to which the main reset pulse is initially applied.

8. The plasma display panel according to claim 7, wherein the misfiring erase pulse performs discharging and erasing under a predetermined condition.

9. The plasma display panel according to claim 7, wherein the predetermined condition includes having charges excessively formed during the reset period, and wherein the charges excessively formed are discharged and erased by the misfiring erase pulse.

10. The plasma display panel according to claim 7, wherein the misfiring erase pulse is applied after a main reset pulse is applied during a reset period of a subfield applied with the main reset pulse, the subfield coming after a subfield applied with a sub reset pulse.

11. The plasma display panel according to claim 7, wherein in the case that subfields to which the main reset pulse is applied are consecutive, the misfiring erase pulse is applied after the subfield to which the main reset pulse is initially applied from among the consecutive subfields.

12. The plasma display panel according to claim 10, wherein in the case that subfields to which the main reset pulse is applied are consecutive, the misfiring erase pulse is applied after the subfield to which the main reset pulse is initially applied from among the consecutive subfields.

13. A driving method of a plasma display panel having a plurality of first electrodes and second electrodes, a plurality of third electrodes respectively crossing the first and second electrodes, a discharge cell formed by adjacent first and second electrodes, and third electrodes; and a main reset pulse having a waveform rising to a second voltage from a first voltage and then falling, and a sub reset pulse having a waveform falling from a third voltage to a fourth voltage, the main reset pulse and the sub reset pulse being selectively applied to a plurality of subfields; the driving method comprising:
applying a misfiring erase pulse after a main reset pulse is applied during a reset period of a subfield applied with the main reset pulse, the subfield coming after a subfield applied with a sub reset pulse.

14. A plasma display panel comprising:
a plurality of first and second electrodes formed in parallel;
a plurality of third electrodes crossing the first and second electrodes; and
a driving circuit supplying a driving signal to a discharge cell formed by adjacent first and second electrodes, and third electrodes, and selectively applying a main reset pulse having a waveform rising to a second voltage from a first voltage and then falling and a sub reset pulse having a waveform falling from a third voltage to a fourth voltage during a reset period throughout subfields,
wherein the misfiring erase pulse is applied after a main reset pulse is applied during a reset period of a subfield applied with the main reset pulse, the subfield coming after a subfield applied with a sub reset pulse.

15. A method of driving a plasma display panel having scan electrodes, sustain electrodes and address electrodes, the scan electrodes, sustain electrodes and address electrodes being driven by a plurality of respective sub-fields, each sub-field having at least a reset period, an address period and a sustain period, the method comprising:
during the reset period, the reset period having an erasing period followed by a ramp rising period followed by a ramp falling period, erasing in the erasing period charges formed due to a sustain discharge during a sustain period of a previous subfield, forming in the ramp rising period wall charges at a corresponding scan electrode, sustain electrode, and address electrode, and partially erasing in the ramp falling period wall charges formed during the ramp rising period;
selectively including a misfiring erase period following the reset period, for further erasing wall charges formed in a plurality of discharge cells;
during the address period following a selectively applied misfiring period, selecting a discharge cell from among the plurality of discharge cells for triggering an occurrence of sustain discharging; and
during the sustain period following the address period, alternately applying a sustain pulse to the scan electrode and the sustain electrode to sustain-discharge the discharge cells which have been selected in the address period.

16. The method of claim 15, wherein during a beginning portion of the misfiring period, a square pulse is applied to the scan electrode while the sustain electrode is maintained at a first voltage and during an ending portion of the misfiring period, the scan electrode is maintained at the reference voltage while an erasing ramp waveform gradually rising from the reference voltage is applied to the sustain electrode.

17. The method of claim 15, wherein
during the sustain period, voltages are alternately applied to the scan electrode and the sustain electrode, the voltages having the same absolute value but opposite signs.

18. The method of claim 15, wherein during a beginning portion of the misfiring period, the scan electrode is maintained at a first voltage while a reference voltage is applied to the sustain electrode, and during an ending portion of the misfiring period, a ramp voltage falling from the first voltage to the reference voltage is applied to the scan electrode while the sustain electrode is maintained at a second voltage greater than the first voltage reference.
